(19) United States
(12) Patent Application Publication
(10) Pub. No.: US 2016/0063403 A1
(43) Pub. Date: Mar. 3, 2016

(54) ASSET ACQUISITION AND MANAGEMENT METHOD AND SOFTWARE

(71) Applicant: Jason SMITH, Comstock Park, MI (US)

(72) Inventor: Jason Smith, Comstock Park, MI (US)

(21) Appl. No.: 14/786,244

(22) PCT Filed: Apr. 24, 2014
(86) PCT No.: PCT/US14/35263

§ 371 Date: Oct. 22, 2015

Related U.S. Application Data
(60) Provisional application No. 61/815,462, filed on Apr. 24, 2013.

(51) Int. Cl. G06Q 10/06; G06Q 30/06; G06Q 10/08; G06F 17/30

(52) U.S. Cl. CPC G06Q 10/0631; G06F 17/30339; G06F 17/30595; G06F 17/30424; G06F 17/30371; G06F 17/30867; G06F 17/3056; G06Q 30/0603; G06Q 30/0633; G06Q 10/087

(57) ABSTRACT

Vendors and customers join a purchasing consortium which maintains vendor and customer databases, and a product catalogue database. Vendors enter product, product pricing and product maintenance data into product catalogue database. A customer searches the catalogue data base and purchases product selected from product catalogue. The purchasing customer's information from the customer/vendor database, and the product product, pricing and product maintenance data for the selected product or products, are linked to an inventory and/or customer asset management data base, such that the customer can retrieve, use and manipulate the product, product pricing and product maintenance data in connection with the management of the assets purchased. Purchase payments are processed to the appropriate vendor, and optionally a portion thereof to the consortium manager.

### CROSS REFERENCE TO RELATED APPLICATIONS

The present application claims the benefit of U.S. Provisional Patent Application No. 61/815,462, entitled ASSET ACQUISITION AND MANAGEMENT METHOD AND SOFTWARE, filed on Apr. 24, 2013, the entire contents of which are incorporated by reference.

### FIELD OF THE INVENTION

The present invention relates to the field of product or service purchase and to the separate field of asset management.

### BACKGROUND OF THE INVENTION

Software is available by which a purchaser can record purchases and enter asset management data concerning the purchase. Such data can be used to track and maintain the purchase.

### SUMMARY OF THE INVENTION

In the present invention, vendors and customers join a purchasing consortium which maintains vendor and customer databases, and a product catalogue database. Vendors enter product, product pricing and product maintenance data into product catalogue database. A customer searches the catalogue data base and purchases product selected from product catalogue. The purchasing customer's information from the customer/vendor database, and the product, product pricing and product maintenance data for the selected product or products are linked to an inventory and/or customer asset management data base, such that the customer can retrieve, use and manipulate the product, product pricing and product maintenance data it connection with the management of the assets purchased.

These and other features, objects and advantages of the invention will be more fully understood and appreciated by reference to the Description, of the Preferred Embodiments, and the appended drawings.

### BRIEF DESCRIPTION OF THE DRAWINGS

FIG. 1 is a schematic showing the relational tables of the consortium management software;

FIG. 2 is a schematic showing the relational tables of the consortium management software which are directly involved in a purchase;

FIG. 3 is a schematic showing relational tables involved in a customer resale of a product to one of the customer's customers;

FIG. 4 shows the dashboard 15 generated by home screen table 14.

### DESCRIPTION OF THE PREFERRED EMBODIMENTS

### Introduction

In the preferred embodiment, vendors and customers may pay a fee to and enter into a license agreement with the consortium manager in order to participate in the purchasing consortium and have online access to the consortium management software. Vendors can also be customers, and vice versa. Vendors and customers are sometimes called “users.” The consortium manager use consortium management software to maintain a vendor and customer database table 10, and a product catalogue database table 20. In the preferred embodiment, the method and consortium management software may be used for providing and purchasing services as well as products. Thus the term “product” as used herein refers to both products and services.

### Consortium Management Software

In the preferred embodiment, the consortium management software is written in an entry related database such as ERD and converted to MySQL and PHP. The consortium management software source code is maintained cm the consortium manager's server. User's access and use the software on-line.

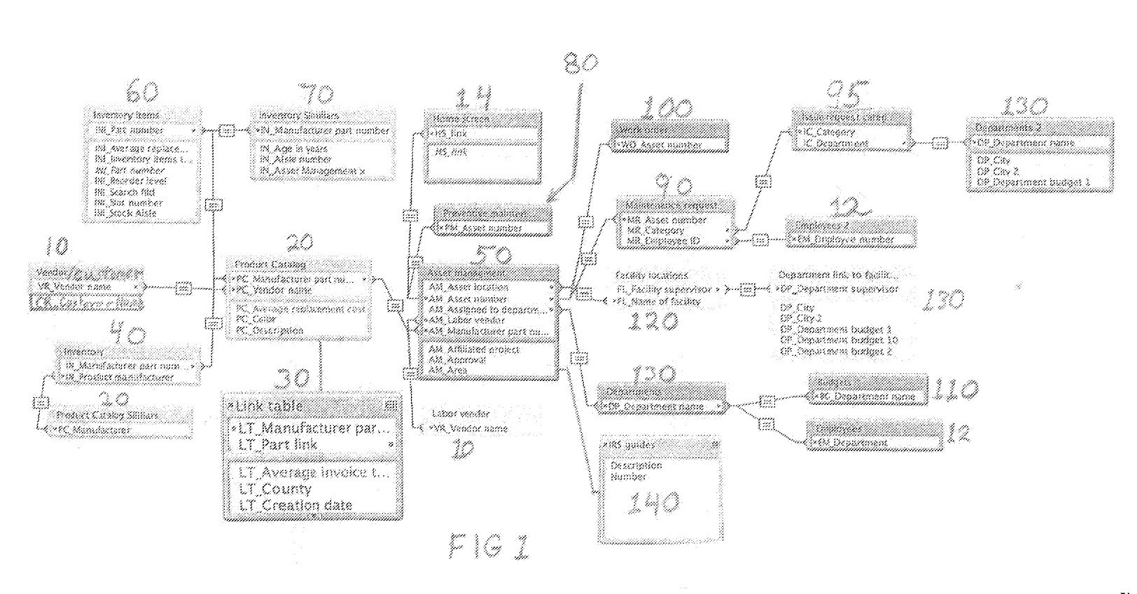

The primary data tables are the vendor/customer database table 10 and the product catalogue database table 20. The information contained in these tables is related to other relational tables through coded entries in those other tables. Data in any table which is pertinent only to a particular user is so coded by association with user's identification rode and/or password. All of the relational tables in the software are networked together and contain data pertinent to many if not all users in the consortium (FIGS. 1-3). In addition, there are non-relational tables which are provided primarily as a convenience to users of the system. In the figures, some of the tables are shown in separate parts. Each such separate part is given the number of the table, thus indicating that they are part of the same table. Preferably, the software comprises the following relational tables in which data items are recorded and manipulated:

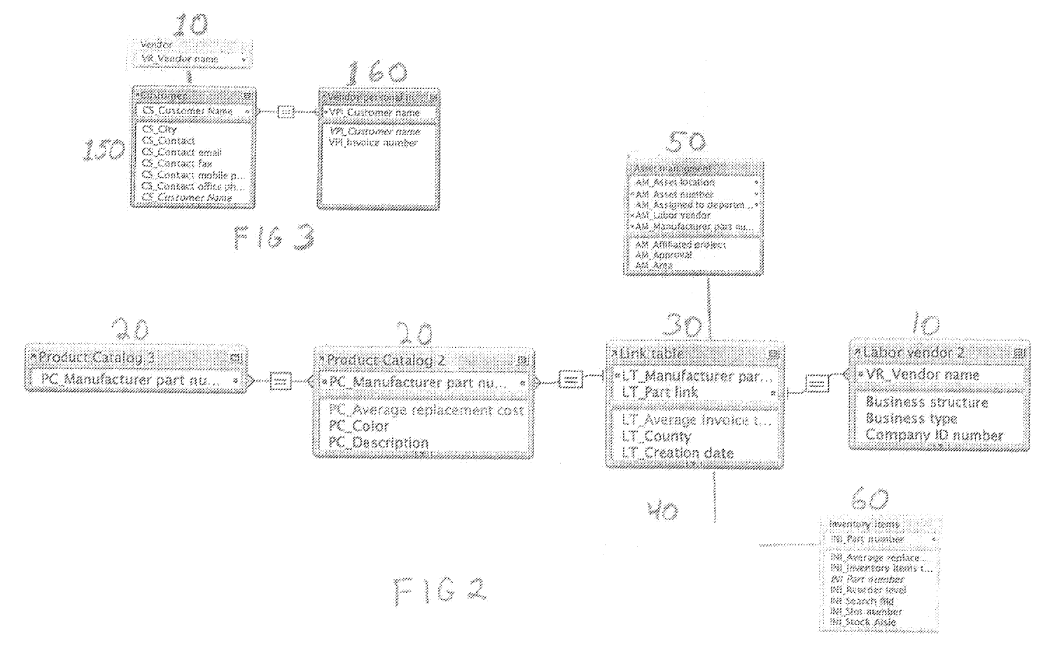

### Vendor/Customer Table 10 (FIG. 1, FIG. 2)

List of and personal data for consortium vendors and customers.

### User's Authorized Employees Table 2 (FIG. 1)

List of all the authorized employees and their passwords users have entered.

Home screen Table 14 (FIG. 1)

Each user has ha own home screen, all of which are in this table.

Product catalog Table 20 (FIG. 1, FIG. 2)

Product, product pricing, product maintenance and other critical information in regards to all items that were entered by vendors.

### Link Table 30 (FIG. 1, FIG. 2)

This table links the purchasing activity to the other tables in the system, and records relational data concerning the purchase in those tables. Maintains invoices of what is purchased through the purchasing consortium so users can see what they have purchased from the consortium.

### Inventory Table 40 (FIG. 1)

Records b user number and manufacturer's part number all the items a user has put into a user's inventory.

### Asset Management Table 50 (FIG. 1)

Records by user number and manufacturer's part number all the items a user has put into a user's asset management database. When a user enters the fact that an asset is in use,” this table tracks depreciation and warranty expiration information.

### Cumulative Inventory Items Table 60 (FIG. 1)

Arranges all the different items in inventory table into collective groups, and tracks a user's inventory counts, providing reorder alerts.

### Inventory Look Up Table 70

Processing table that takes items out of inventory table 40 and places them in asset management table 50 and preventive maintenance table 80.

### Preventive Maintenance Table 80

Product numbers in this table link to all preventive maintenance schedules for products which are “in service.” This table generates preventive maintenance schedules using this information, as well as email preventive maintenance reminders to appropriate employees. Information can be manually entered for items not purchased though the consortium.

### Maintenance/Issue Request Table 90

Processes intra customer work requests. Keeps records of issues that users have with everything from building maintenance to software support for all of their products.

### Maintenance/Issue Request Categories Table 95

Provides a list of different categories of problems such as facilities, tech, etc., and will process requests for a summation of maintenance requests and issues raised by date range and category.

### Work Order Table 100

Provides functionality for preparing and processing work orders, and maintains a record thereof.

### Budgets Table 110

Keeps track of all the customer's department budgets, and how much the department has spent and has left to spend. Each customer is allowed as many departments as they would like. Each department is allotted up to eight budgets.

### Facility Locations Table 120

List of facility locations that users have entered.

### Departments Table 130

List of all the different departments for each of the users.

### IRS Guides Table 140

A complete list of all the IRS categories for our users to pick from so they can be placed in the right category.

### User's Customers Table 150

Maintains profiles of user's customers, winch are entered by user.

### User Personal Invoices Table 160

Processes invoices from a user to the user's customers, and maintains a record thereof. These can be resale of consortium purchased products, or they can be entirely :separate sales entered manually by the user.

The following are non-relational tables preferably included in the consortium management software, some of which are included as a convenience to the users:

### Passwords Table 170

Keeps records of passwords that users have entered. These may or may not relate to consortium matters.

### User's Contacts Table 1.80

This table facilitates transfer of a user's contacts to this table.

### Tasks: Table 190

Keeps records of tasks that users have placed here.

### Consortium Issue Requests Table 200

Table of any problems users have with the consortium or consortium vendors or customers. Processes notification of issues to the consortium manager, and to the indicated vendor or customer.

### Vendor Product Entry

Once a vendor has signed the vendor contract agreeing to the online licensing program of the consortium manager, vendor chooses a hid package as offered by the consortium manager. A bid package is simply the number of products the vendor wants to bid on. The consortium manager may have a minimum bid package, e.g. 300 items, and then offer larger packages with 400, 500, etc. items in them. Vendor then signs into the system using a system set up wizard located in the vendor/customer table 10. The wizard includes bid requirements. The bid requirements may be set by the consortium manager, or the consortium manager may use bid requirements of a major customer, or the bid requirements of a state, especially if state agencies and educational institutions are to be major customers of the consortium. Bid requirements may change each year, especially if state bid requirements are being used.

Each vendor inputs its products into product catalog table 20. For each product placed, the vendor must provide all information the consortium manager has determined necessary to make all system functionalities work. A counter in this table reduces the purchased bid package number by one for each product entered. When the counter reaches zero, the vendor will not be able to enter any further items. Exemplary information which might be required for each product entered includes:

Manufacturer part number

Product category

Sub category

Manufacturer

Individual cost

Vendor warranty

Manufacturer warranty

Shipping method

Color

Weight

Life expectancy

Product website

Description

Notes

Preventive maintenance schedule

### Customers

Customers may be divided into classes based on factors such as their purchasing volume, their profit or non-profit status, their status as public institutions, the age of the company, and etc. Category 1 customers may purchase at the bid price plus a small over-ride fee such as 4%, while category 2 and 3 customers purchase at the bid price plus somewhat larger over-ride fees, such as 10% and 15% respectively. As an incentive to bid lower prices, vendors may be made category 1 customers if they have succeeded in being low bidder on at least one item. Examples of customers which might be made category 1 customers include:

Schools public and private

Federal government agencies and departments

State government agencies and departments

Local government agencies and departments

Fire departments

Police departments

Ambulance services

Nursing homes

Assisted living companies

Universities and higher education facilities

Charity and non-profit organizations

New companies that are under 5 years of age

Vendor companies that are the winner of one or more lowest bid items.

Vendors who participate but are not low bidders on any product might be placed in category 2, at 10% over-ride, while the remaining customers, carted “retail customers” herein, might fall into category 3. Preferably when a customer is searching the catalogue, the software automatically adds the override fee to the bid price, such that the customer sees only the final price the customer has to pay for the product. Further in the case of category 3 customers the link table 30 might be programed to automatically select asset management, or an abbreviated version thereof, for that customer's purchases.

### Access and Dashboard Functions

Vendors/customers will choose which representatives from their company will be allowed access to the consortium management system. Users will also determine what access each employee will be allowed. The consortium manager will provide passwords to each of the authorized representatives and allow access to the correct home screen and other authorized tables. This information for each employee will be maintained in employee table 12.

As user information is entered in vendor/customer table 10, a home screen or dashboard 15 for the user is generated in home screen table 14. Home screen table 14 is linked not only to vendor/customer table 10, but also to all other tables in the system. Thus the home screen table 14 generates a dashboard 15 (FIG. 4) which shows the user its personal information at a glance.

### Customer Purchase

The software tables involved directly in a customer purchase are shown in FIG. 2. A customer wishing to purchase products enters pertinent company data, including credit card payment information and the like, into the vendor/customer table 10. The customer uses the search function of product catalogue table 20 to identify by product number a specific product it wishes to purchase, or to identify and search for a specific type of product. The customer may indicate that it wishes to purchase at the lowest price, or from a particular vendor, or that it would like to “search all.” Without preference entry by the customer, the system may default to identifying the product originating from the vendor who bid the lowest price.

Items selected by the customer for purchase are placed in the “virtual shopping cart,” which is located in link table 30. Link table 30 links the customer's data from the vendor/customer table 10. As the customer shops, product catalogue data on items placed in the “cart” is also linked to Link table 30. For each item, the customer indicates whether they wish to put the product in inventory table 40, or place it in asset management table 50, or both. The customer also has the choice of adding:

a customer specific purchase order number;

a customer specific project number; and

the name of the person who made the purchase.

When the customer is finished shopping, he or she “clicks” submit. The link table generates an electronic invoice, the customer approves payment and the link table forwards the payment information to a designated bank or payment processing center, with instructions to distribute “fee” portion et the money to the consortium manager, and the remainder of the payment to the vendor. Linking data concerning the items purchased is communicated to in table 40 and/or asset management table 50, if either or both have been selected, for future use in inventory management and/or asset management. Items in inventory table 40 are further linked to cumulative inventory items table 60, which arranges all the different items in inventory table into collective groups with pertinent information, and tracks a user's inventory counts for the group items, providing reorder alerts.

Vendors of each item purchased will receive an email providing the following information:

1. The consortium purchase order number;

2. The customer purchase order number;

3. The customer project number, if any;

4. The customer's inventory number and inventory location information;

5. The customer's asset number;

6. Mailing label for pre-paid shipping to the customer.

The vendor prints this email on special adhesive backed label stock, with release liner protecting the adhesive. The asset number will be printed on a portion of the label which is separable from the rest. The label is then placed in a clear plastic envelope which is adhered to the container in which the product is shipped to the customer, with the shipping information clearly visible. The customer thus receives the product with all pertinent purchasing, inventory and asset information printed directly on the label on the container in which the product arrived.

### Receiving Product

Customer will receive product by shipping carrier. Product will conic with inventory stocking information attached along with inventory number and asset number if they were chosen when purchased. The product will already be entered in the inventory table 40 if that option was accepted at the time of purchase, so there is no need to check the product into inventory manually.

With the product already in the inventory table 40, linked to the cumulative inventory item table 60, all of the key inventory information for the product can be tracked and used as the system starts generating this key portion of the information flow:
Stock level
Stock location
Reorder level
Which purchase order the product came from
Status of product

### Placing Product in Use

Upon arrival, the product will be placed in inventory, if that is what is indicated on the shipping label. If not, the product will simply be placed in use. At the time the product is plated in use, the asset number sticker is peeled off of the shipping label and applied to the product.

A product “in inventory” is monitored in inventory table 60 of the consortium management software. A product “in use” is monitored in the asset management table 50 of the system. There are several ways dun a product can be indicated in the consortium management software as being “in use.” Items in inventory table 60 are also linked to inventory look up table 70. Table 70 is used by the user to “transfer” an item from inventory table 40 to asset management table 50. This indicates that the item is now “in use,” and various asset management functions will become active. A product which at the time of purchase was placed in asset management table 50 but not in inventory table 40 will not be subject to the asset management functions until the user indicates that the product is “in use.” For a product which was placed in both the inventory table 40 and the management table 50 at the time of purchase, the “transfer” at the product out of inventory table 40 will be the signal to the asset management table 50 that the product is now “in use.”

The asset management table is activated to calculate and start generating all of the key asset management information, based on linked information in the product catalogue table 20. Such information may include:
Remaining life
Depreciation
Current book value
Labor warranty end
Vendor warranty end
Manufacturer warranty end
Labor warranty days left
Vendor warranty days left
Manufacturer warranty days left
Replacement cost
Department product is assigned to
Department product is allocated for

### Maintenance of Product

Once an asset is recorded as being “in use” in the asset management table 50, the product number is inserted into the preventive maintenance table 80, which links table 80 to the preventive maintenance information contained in the product catalogue table 20. The preventive maintenance schedule can be displayed for ever product which is “in service.” In addition, preventive maintenance table 80 includes a program to generate email reminders to responsible employees of the need to perform preventive maintenance from time to time.

Unscheduled maintenance of any product may be requested through the maintenance issue request function provided by the maintenance request table 90 of the consortium management system. This table processes intra customer work requests. It keeps records of issues that users have with everything from building maintenance to software support for all of the user's products.

To issue a maintenance or issue request an employee inputs the following information:
His or her employee ID number;
The asset number;
A written description of the problem;
Two images of the product showing the problem, if possible;
A voice recording explaining the problem or other significant sound recording pertaining to the issue;
If the purpose of the request is to merely inform the system and appropriate personnel of an issue related to the product, without requesting maintenance, the requester so indicates on the request.

The following information is then auto filled into the request:
The employee's ID number causes auto fills from employee table 12 of the employee's following information: first name, last name, email and phone number;
An issue request number;
The asset number automatically inputs the asset's information from the asset management table 50, such as remaining life, depreciation, current book value, labor warranty end, vendor warranty end, manufacturer warranty end, labor warranty days ten, vendor warranty days left, manufacturer warranty days left, replacement cost, associated assets, department the product is assigned to, location of the product and the department the product is allocated for;
Also automatically in filled may be a listing of any prior issues or maintenance requests recorded in the maintenance and issue request table 90 for this product or others like it and any prior work done on the product or others like it from the work order table 100.

Once a request has been submitted the maintenance request table 90 generates and sends the request via email to the person responsible for maintenance of the indicated product, and an automatic email response to the employee that requested the maintenance, confirming that the request has been issued and sent.

### Maintenance/Issue Request Administrative Review

Once a maintenance or issue request has been submitted, the information is directed to the administrative person in charge of the subject matter of the request. If maintenance has been requested, the person in charge will either approve or approval or decline the request, and may instead propose alternative action, such as purchase of a replacement.

As indicated above, the work request includes many items or important information pertaining to the asset to help make an informed decision without having to physically view the product. After a look at the problem and the information, the administrative user can prepare a work order using the work order table 100 functionality. The administrator inputs the following information in preparation of a Work Order:
Identification of the responsible employee
The issue request number
Approval
Priority level
Budget for the work
Estimated completion

Then with an “approval” click, the following information is auto filled into the work order:
Work order number
Request date
Completion status
Asset number
Requested by
The maintenance/issue request, and all of the information associated with it.

There is also a time tracking portion on the work order itself that will track an employee's total time for up to five days to help keep track of employees and the time it takes to fix specific types of products. The employee responsible then indicates completion of the product in the “completion status” box of the work order in its electronic format.

The administrator may as an alternative to issuing a work order, issue a purchase order, or request a purchase order, for replacement of the product involved.

### Miscellaneous Relational Tables

Budgets table 110 keeps track of all the customer's department budgets, and how much the department has spent and has left to spend. Each customer is allowed as many departments as they would like. Each department is allotted up to eight budgets.

Facility locations table 120 lists the facility locations that users have entered. This information is used by the asset management table 40, the maintenance request table 90 and the work order request table 100, as it is useful in the maintenance process.

Departments table 130 maintains a list of all the different departments for each of the users. That information is used by the budgets table 120 and by the maintenance request table 90 and the work order request table 100, as described above.

IRS guides table 140 provides a complete list of all the IRS categories for products, and provides depreciation information for such products for use by the asset management table 50. Table 140 may process and identify the correct table for the various products, or may require users to select the appropriate category.

### User's Resale and Unrelated Sales

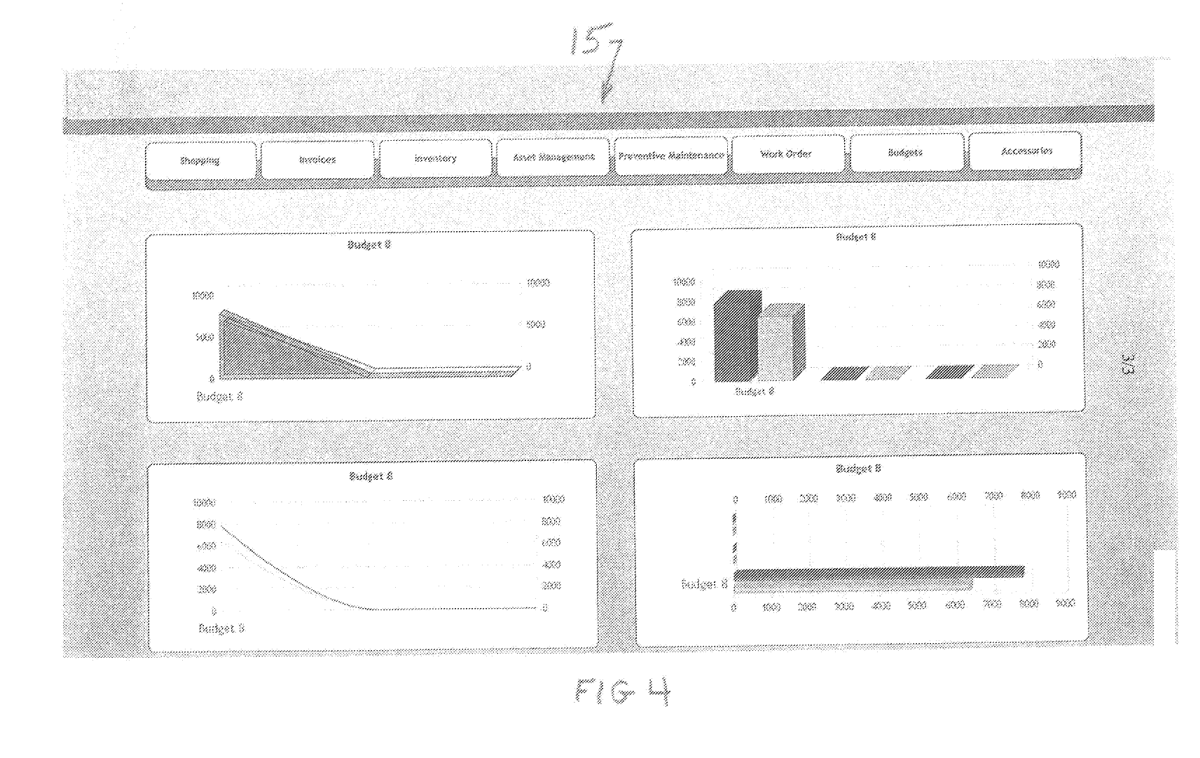

The consortium management software facilitates a user's resale of items purchased through the consortium (FIG. 3). It can also be used to sell products not included in the consortium. The user's customers table 150 maintains profiles of user's customers for such products. The user enters its customers into table 150.

The user personal invoices table 160 facilitates user's preparation, of invoices to its customers, including adding the facilitator's mark up over any bid or acquisition price, and processes such invoices from user to user's customers, either for product bought by the user from the consortium and resold, or for product acquired independently of and/or not included in the consortium. Table 160 maintains a record thereof. Payment is accomplished through the consortium links table 130, and monies are dispersed from the sale in the manner described above, but with the reseller or new seller being considered the vendor.

### Non-Relational Tables

Passwords table 170 provides, a database into which a user may enter various passwords the user wants to keep track of. These may or may not relate to continuum matters.

User's contacts table 180 facilitates transfer of a user's contacts to this table, and makes them accessible to the user in the consortium software. Likewise, tasks table 190 keeps records of tasks that users have placed here.

The consortium issue requests table 200 processes, tracks and provides a record of user complaints against the consortium manager, or against other users. It can be used to processes notification of issues to the consortium manager, and to the indicated vendor or customer.

The foregoing is a description of the preferred embodiments of the invention, and various changes and modifications thereof can be made without departing from the broader concepts of the invention.

1. A method for facilitating, asset acquisition asset management and asset maintenance comprising: providing to users access to consortium management software; providing and maintaining in said consortium management software relational data base tables which are linked together, including a vendor/customer database table, whereby vendor users and customer users can enter their identifying and personal data, and a searchable product catalogue database table; providing in said searchable product catalogue database for receipt from vendor users, product, product pricing and product maintenance data; providing an inventory database table and a customer asset management database table; providing customer users access to said searchable product catalogue database, whereby a customer searches the catalogue data base and purchases product selected from said product catalogue database; providing for association of information in any table which is pertinent, only to a particular user with said users identifying data; inking the purchasing customer's identifying information from the customer/vendor database table, and the product, product pricing and product maintenance data for the selected product or products, to one or both of said inventory database table and/or said customer asset management data base table, such that the customer can retrieve, use and manipulate the product product pricing and product maintenance data in connection with the management of the assets purchased.

2. The method of claim 1 in which a link table is provided to perform said linking step: said link table providing a “virtual shopping cart,” into which items selected by a user customer from said product catalogue database are placed; said link table generates an electronic invoice, for approval by the user customer and maintains invoices of what is purchased for future access by a user customer.

3. The method of claim 2 in which said link table forwards payment information to a designated bank or payment processing, center, with instructions to distribute payment to a user vendor.

4. The method of claim 3 in which said link table also distributes a “fee” portion of a product purchase payment to a consortium manager.

5. The method of claim 2 in which a user customer also has the choice of entering the following information into said link table with respect to each purchase:
a customer specific purchase order number;
a customer specific project number; and
the name of the person who made the purchase.
and records relational data concerning the purchase in those tables, including invoices of what is purchased by a user customer so the use customer can view what they have purchased.

6. The method of claim 2 in which said consortium software assigns a consortium purchase order number and a customer asset number to an asset item purchased by the customer, and sends that information to the vendor for the item purchased, along with mailing label information for printing on label stock by the vendor, for use in shipping to the customer.

7. The method of claim 7 in which said mailing label includes said asset number, and other pertinent purchasing, asset and inventory information; and wherein the vendor prints this mailing label information on adhesive backed label stock, with release liner protecting the adhesive; said asset number being located so as to be printed on a portion of the label which is separable from the rest, whereby the customer receives the product with all pertinent purchasing, inventory and asset information printed directly on the label on the container in which the product arrived, and can separate said asset number portion of said label and adhere it to the product received.

8. The method of claim 2 in which an inventory look up table is provided, which when accessed by a user, takes items selected for in service use by the user, out of said inventory database table and places said items into said asset management table.

9. The method of claim 8 in which a preventive maintenance table is provided which links all preventive maintenance data from said product catalogue table for products which are in service, and generates preventive maintenance schedules using said data.

10. The method of claim 9 in which said preventative maintenance table is programed to generate email preventive maintenance reminders to the appropriate user.

11. The method of claim 10 in which a user can manually enter into said preventative maintenance table the maintenance information for items not purchased through use of said consortium management software.

12. The method of claim 2 in which said asset management table records by user and manufacturer's part number all the items a user has put into a user's asset management database.

13. The method of claim 12 in which said asset management table is programmed to allow a user to enter the fact that an asset is in service, and to thereafter track depreciation and warranty expiration information.

14. The method of claim 13 in which said asset management table is programmed to track depreciation and warranty expiration information for products which have been designated to be in service.

15. The method of claim 2 in which said inventory table records by user and manufacturer's part number all the items a user has put into a user's inventory; and in which a cumulative inventory items table is provided., winch arranges by user all the different items a user has in the inventory table into collective groups, tracks a user's inventory counts, and provides reorder alerts.

16. The method of claim 1 in which a User's Authorized Employees Table is provided, where a user can list of all the authorized employees and their passwords users have entered.

17. The method of claim 1 in which a Home screen table is provided, which gives each user its own home screen.

18. The method of claim 1 in which a Maintenance/issue request table is provided which processes intra customer work requests, and keeps records of issues that users have with products purchased.

19. The method of claim 18 in which a Maintenance/Issue request categories table is provided which categorizes problems and processes requests for a summation of maintenance requests and issues raised by date range and category.

20. The method of claim 19 in which a work order table is provided which enables preparation of and processing for work orders, and maintains a record thereof.

21. The method of claim 1 in which a budgets table is provided which keeps track of all the customer's department budgets, how much the department has spent and has left to spend.

22. The method of claim 1 in which a facility locations table is provided which maintains a list of facility locations that users have entered.

23. The method of claim 1 in which a departments table is provided which lists all the different departments for each of the users.

24. The method of claim 1 in which an IRS guides table is provided which includes a list of IRS categories for users to pick from so assets acquired can be placed in the correct category.

25. The method of claim 1 in which a user's customers table is provided which maintains profiles of a user's customers.

26. The method of claim 1 in which a user personal invoices table is provided in which a user can process invoices from a user to the users customers, which can be for resale of a product purchased from a consortium vendor, or can be entirely separate sales entered manually by the user.

27. The method of claim 1 in which said consortium software also includes user convenience tables which are not related to other tables.

28. The method of claim 27 in which said user convenience tables include: a passwords table for keeping by user a user's passwords; a user's contacts table, for tracking by user the user's contacts; and a user's task table which records by user the tasks a user has listed there.

29. The method of claim 1 in which vendors are asked to bid prices at which they are willing to offer products they wish to offer to user customers, with the lowest bidders receiving preference.

30. The method of claim 30 in which a consortium manager charges an over-ride fee on sales by a vendor, and the preference provided to the lowest bidders is a lower over-ride fee.
